(19) United States
(12) Patent Application Publication
(10) Pub. No.: US 2011/0265386 A1
(43) Pub. Date: Nov. 3, 2011

(54) IMPROVEMENTS IN RELATION TO DOORSILLS

(75) Inventors: David Dunstan, Whangarei (NZ); Ronald Raymond Houben, Whangarei (NZ); Kenneth Alexander Mackay, Whangarei (NZ)

(73) Assignee: Threshold Solutions Limited, Whangarei (NZ)

(21) Appl. No.: 13/003,566

(22) PCT Filed: Jul. 11, 2008
(86) PCT No.: PCT/NZ2008/000167

§ 371 Date: Apr. 1, 2011

(51) Int. Cl. E06B 1/70; E06B 7/16

(52) U.S. Cl. 49/468; 49/506

(57) ABSTRACT

This invention relates to a sill for a door frame, whether a door is hinged, sliding, or bi-fold or otherwise, comprising or including a stationary sill member, whether of unitary or composite construction, a movable sill member with a surface thereon to act as a threshold (hereafter ‘threshold surface’) for said sill, and at least one moving means, wherein said at least one moving means acts on said movable sill member, directly or indirectly to move said movable sill member between, a first position wherein said threshold surface is retracted at least in part toward or within said stationary sill member, and a second position wherein said threshold surface is extended from said stationary sill member, said at least one moving means energised by a controlling event. The invention also relates to a method of providing and installing a sill for a door frame.

### FIELD OF THE INVENTION

The present in invention relates to doorsills that have a threshold that can be raised or lowered (i.e. recessable) when needed.

### BACKGROUND TO THE INVENTION

A sill defines the lower surface of a door and extends between the vertical jambs of the door frame. A threshold extends upwards from the sill and generally faces out from the door frame to form a weather proof seal against the inner surface of the door frame when the door is closed. As such thresholds are generally used for external doors or doors where a prevention of drafts or similar is required. Often thresholds for doors are required to be elevated above the surface level of the surrounding ground for the door to provide weather tightness.

It is often a problem when people are passing through doors (whether folding, sliding or otherwise) that they catch their feet on the threshold of the door sill as it extends higher then the sill and/or the surrounding ground the sill is located in. This, for example often can happen when the person needs to step up from a lower level to pass through the door.

A threshold can also act as an impediment, if not a total barrier, to wheel chairs, walking frames and similar mobility aid devices. In addition a threshold projecting from a sill can act as a surface to catch and retain debris, particularly when the door is open.

In this specification where reference has been made to patent specifications, other external documents, or other sources of information, this is generally for the purpose of providing a context for discussing the features of the invention. Unless specifically stated otherwise, reference to such external documents is not to be construed as an admission that such documents, or such sources of information, in any jurisdiction, are prior art, or form part of the common general knowledge in the art.

It is therefore an object of the present invention to overcome the above problems of door sills and thresholds, and/or to provide the public with a useful choice.

### SUMMARY OF THE INVENTION

In a first aspect the present invention may be said to broadly consist in a sill for a door frame, whether a door is hinged, sliding, or bi-fold or otherwise, comprising or including,

a stationary sill member, whether of unitary or composite construction,

a movable sill member with a surface thereon to act as a threshold (hereafter “threshold surface”) for said sill, and

at least one moving means,

wherein said at least one moving means acts on said movable sill member, directly or indirectly to move said movable sill member between,

a first position wherein said threshold surface is retracted at least in part toward or within said stationary sill member, and

a second position wherein said threshold surface is extended from said stationary sill member,

said at least one moving means energised by a controlling event.

Preferably said controlling event is linked to said door position relative said frame.

Preferably said at least one moving means is energised to move said movable sill member and extend said threshold surface to said second position when said door is closed in said door frame.

Preferably said event is the opening of said door to energise said at least one moving means to move said moveable sill member to said first position and retract said threshold surface.

Alternatively said at least one moving means is energised independent of said door position.

Preferably said controlling event is linked to wind or wind pressure or the presence of moisture to cause said movable sill member to move to said second position and extend said threshold surface.

Preferably said threshold surface and said movable sill member move in the vertical direction between said first position and said second position.

Preferably said threshold surface is located on an extension or a recess (hereafter “threshold portion”) of said movable sill member.

Preferably said threshold portion is at least one elongate member, extending from said movable sill member, running lengthwise along said sill and extending to engage against a substantially vertical surface of said door when said door is in said frame and said threshold portion is extended.

Alternatively said threshold surface is provided as at least one surface of a vertical recess in said movable sill member, or part thereof.

Preferably said movable sill member is a unitary member, for example an extrusion.

Alternatively said moveable sill member is a composite member assembled from several individual members, for example several extrusions.

Preferably there is a seal formed by a sealing element between said door, when in said frame, and said movable sill member.

Preferably there is a cushioning element between said door and said threshold surface, with either,

a cushioning element on said threshold surface to cushion against a surface of said door, or

a cushioning element on said door, or a part thereof, to cushion against said threshold surface,

or both,

when said door is in said frame and said threshold surface is extended.

Preferably said cushioning element acts as guide in addition to being a cushion.

Preferably said cushioning element acts as said sealing element also.

Preferably there is a said sealing element located on a downward facing surface of said door to seal against a horizontal portion of the threshold surface, when said door is in said door frame.

Preferably said at least one moving means is energised by any one or more of,

i) a spring

ii)

iii) a liquid

iv) an electrical system, such as a linear or a rotary motor, or

v) any combination of (i), (iii) or (iv).

Preferably said at least one moving means is an air actuated bladder. Preferably said at least one moving means is adjustable mounted to or on said stationary sill member.

Preferably said at least one moving means is mounted on a platform that is adjustable relative to said stationary sill member.

Preferably said threshold surface lies flush with or below an upper surface of said stationary sill member when said moveable sill member is in said first position.

Preferably said threshold surface is extended from an elongate aperture in said stationary sill member or a blanking member in or on said stationary sill member.

Preferably said threshold portion has a closing portion that closes off said elongate aperture when in said first position.

Preferably there are guides to guide said movable sill member between said first and second position.

Preferably said guides lie between vertical faces of said movable sill member and vertical faces of said stationary sill member.

Preferably, the movable sill member is operable to a position intermediate of said first and said second positions. More preferably said movable sill member, and therefore said threshold portion can assume a position intermediate of said first and said second positions.

Preferably said sill is installed such that said upper surface is substantially flush with ground surfaces into which said sill is installed.

Preferably said movable sill member can be locked or is lockable, directly or indirectly in either said first position, said second position or an intermediate position between said first and said second positions.

Preferably said movable sill member is energised to extend should said moving means fail for any reason.

Preferably said wherein said stationary sill member is of a unitary or a composite construction.

Preferably said stationary sill member is constructed of an upwardly opening U-shaped sill set out tray or channel, whether of unitary or composite construction.

Preferably said stationary sill member is constructed from two end pieces and a base piece to define the sides and base respectively of the upwardly opening U-shaped sill set out tray or channel.

Preferably said upwardly opening U-shaped sill set out tray or channel is in part closed by one or more blanking members to define said elongate aperture.

Preferably said one or more blanking members are of a composite construction, having a top blanking member and a bottom blanking member.

Preferably said blanking members at least in part clip into said upwardly opening U-shaped sill set out tray or channel at either side of said tray or channel.

Preferably said at least one moving means is contained in or on a sill tray located at least in part within said upwardly opening U-shaped sill set out tray or channel.

In a further aspect the present invention consists in a method of providing a sill, comprising or including, providing a sill with a movable portion therein to extend and retract a threshold surface therefrom,

extending said threshold surface from said sill to seal against a door when said door is at least in proximity to said sill,

retracting said threshold surface into said sill when said door is at least not in proximity to said sill, said threshold surface when retracted providing a substantially smooth uninterrupted upper surface of said sill.

A method of installing a sill with a movable threshold, comprising or including the steps of,

i) locating a stationary sill member in or with a door frame, whether in situ or otherwise,

ii) installing a at least one moving means and a movable sill member adapted to be moved by said at least one moving means, either as individual components or a subassembly into said stationary sill member,

iii) locating blanking members to provide an elongate aperture for a threshold portion of said movable sill member to extend from and retract at least in part into.

Preferably a control means to control said at least one moving means is installed at any step in said method.

Preferably a temporary blanking member is located over the stationary sill member during construction and installation of the sill.

Preferably a temporary blanking member is located over the stationary sill member between steps i) and during construction and installation of the sill.

Preferably said door frame is a door frame that is then installed in an opening in a building to then be closed or is closable by a door, whether said door is located or is to be located, in said door frame.

Preferably said door is hinged, sliding, or bi-fold or otherwise moveable relative to said sill or door frame.

A kit or combination to provide a movable threshold sill or door frame with a movable threshold sill, said kit or combination comprising or including,

a sill assembly having a stationary sill member, a movable sill member and a threshold surface extending there from,

at least one movable means to move said movable sill member, and optionally a control to control energisation of said movable means.

In a further aspect the present invention consists in a set of extrusions for a movable threshold sill as herein described with reference to any one or more of the accompanying drawings.

In yet a further aspect the present invention consists in a door frame with a retractable threshold as herein described with reference to any one or more of the accompanying drawings.

In yet a further aspect the present invention consists in a building with a movable threshold sill as herein described with reference to any one or more of the accompanying drawings.

As used herein the term “and/or” means “and” or “or”, or both.

As used herein “(s)” following a noun means the plural and/or singular forms of the noun.

The term “comprising” as used in this specification means “consisting at least in part of”. When interpreting statements in this specification which include this term, the features prefaced by that term in each statement all need to be present, but other features can also be present. Related terms such as “comprise” and “comprised” are to be interpreted in the same manner.

It is intended that reference to a range of numbers disclosed herein (for example, 1 to 10) also incorporates reference to all rational numbers within that range (for example, 1, 1.1, 2, 3, 3.9, 4, 5, 6, 6.5, 7, 8, 9 and 10) and also any range of rational numbers within that range (for example, 2 to 8, 1.5 to 5.5 and 3.1 to 4.7).

This invention may also be said broadly to consist in the parts, elements and features referred to or indicated in the specification of the application, individually or collectively, and any or all combinations of any two or more of said parts, elements and features, and where specific integers are mentioned herein which have known equivalents in the art to which this invention relates, such known equivalents are deemed to be incorporated herein as if individually set forth.

### BRIEF DESCRIPTION OF THE DRAWINGS

Preferred embodiments of the present invention will now be described with reference to the accompanying drawings whereby,

FIG. 1a shows a normal hinged door in a frame in perspective view,

FIG. 1b shows a bi-folding door in horizontal sectional view, each of the doors having a sill and a threshold,

FIG. 1c shows a sliding door in horizontal sectional view,

FIG. 2 shows a cross section through line AA of FIG. 1a of the present invention showing the sill with recessable threshold, the threshold shown in elevated condition to engage against a door,

FIG. 3 shows the same cross section as FIG. 2 where the threshold extension is retracted to lie flush with the sill of the door,

FIG. 4 shows the example extrusions for the present invention and show at,

FIG. 4a the sill tray, as the stationary sill member,

FIG. 4b the sill housing or set out tray, as part of the stationary sill member,

FIG. 4c the sill itself as the movable sill member,

FIG. 5 Shows the top sill cover A) and under sill cover B) to form the blanking member,

FIG. 6 shows a building with the present invention installed,

FIG. 7 is a cross section similar to FIG. 2 showing a floor that is located on top of the sill surface and a threshold extension on the threshold portion,

FIG. 8 shows a similar cross section to FIG. 2 of only the sill set out tray installed with a temporary blanking member in place to prevent debris entering the tray during construction,

FIG. 9 shows a vertical cross section through a further embodiment for a multi-panel sliding door with recessable threshold, with the recessable threshold in the raised condition,

FIG. 10 shows the view of FIG. 9 with the recessable threshold in the depressed condition within the door sill,

FIG. 11 shows the same view as FIG. 10 with the multi panel sliding door removed,

FIG. 12 shows the door guide extrusion in vertical cross section,

FIG. 13 shows the sill guide cover cap again in vertical cross section,

FIG. 14 shows the right hand side leg of the movable sill member of the recessable threshold,

FIG. 15 shows a similar view to FIG. 14 showing the left hand side extrusion for the side leg of the movable sill member for the recessable threshold,

FIG. 16 shows a vertical cross section in the extrusion for the side stop plate including mohair or guiding element,

FIG. 17 shows one unit as a sill plate of the moveable sill member, and

FIG. 18 shows in vertical cross section the extrusion for the sill tray leg.

### DETAILED DESCRIPTION OF PREFERRED EMBODIMENTS

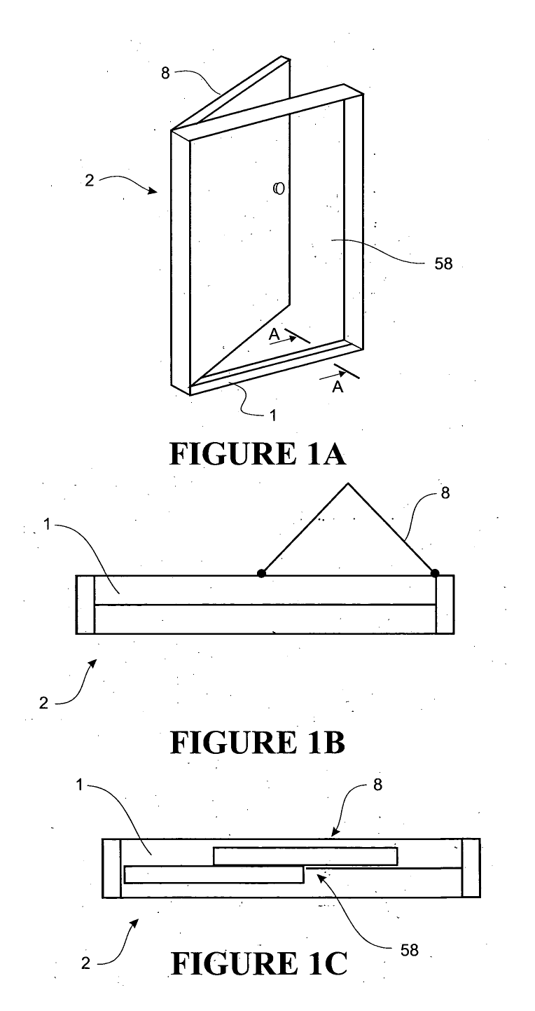

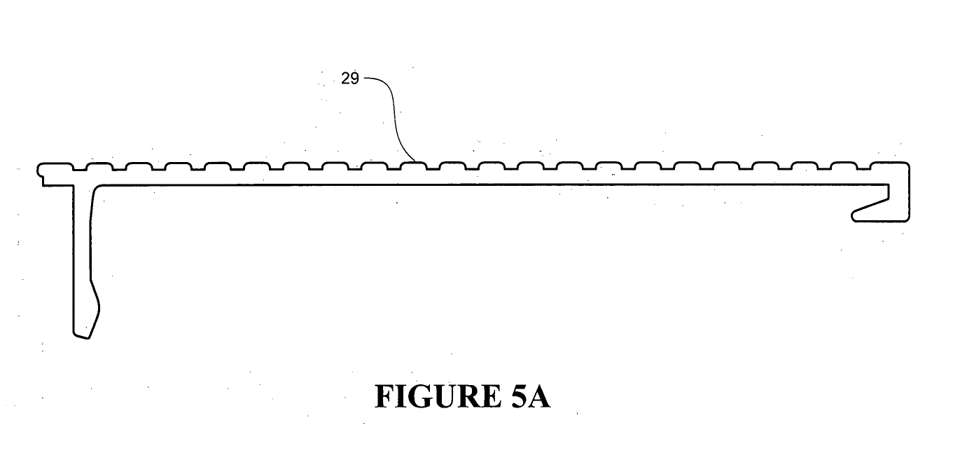

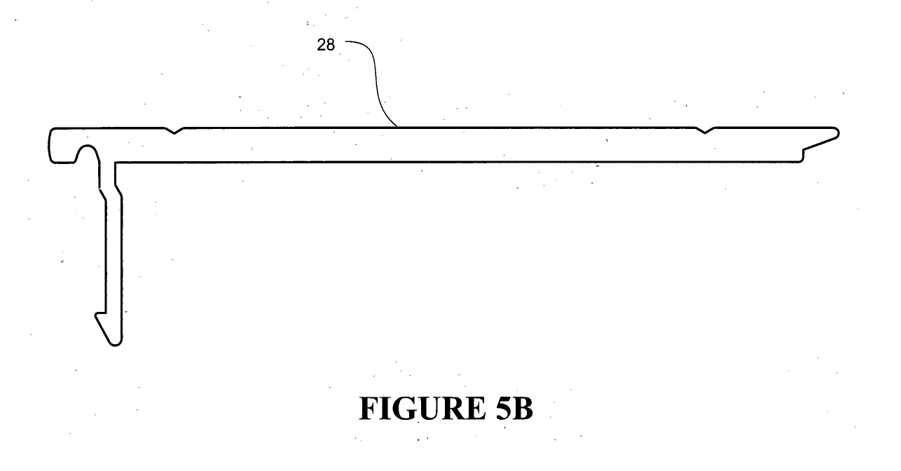

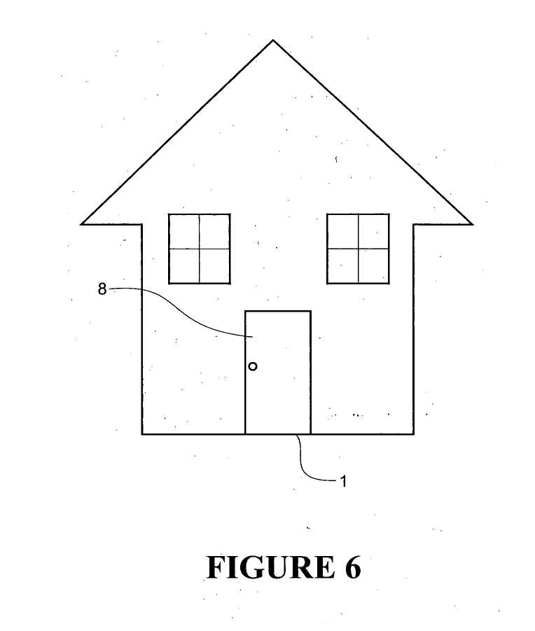

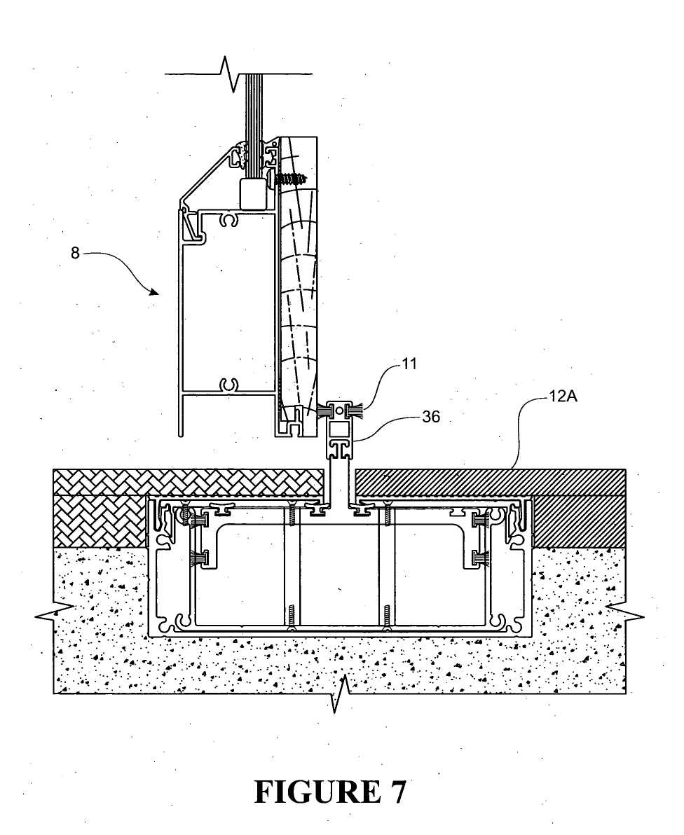

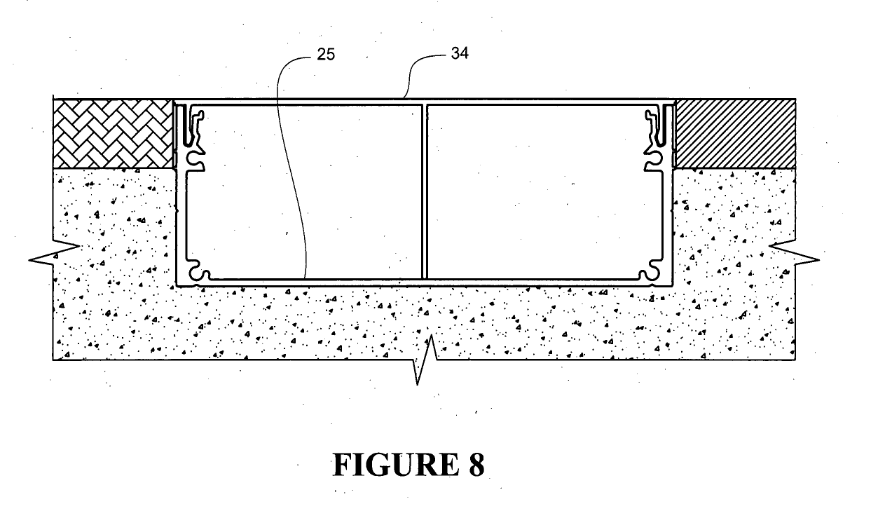

With reference to FIGS. 1 through 8 there is shown a first embodiment of the present invention.

A sill (1) forms the bottom part of a door frame (2). The frame (2) can be for a door (8) that is hinged as in Figure la or consist of multiple panels as in Figure lb to form a bi-fold or can be a sliding door that slides within the periphery of the frame as shown in FIG. 1c.

It is to be understood that the present invention can be installed as part of forming a door frame at a building site or may form part of a door frame assembly that is made off site and transported as a unitary assembly for incorporation in a door opening or building.

In yet other embodiments the present invention may be installed as a retrofit to an existing non-moving threshold installation. As such it may also be supplied as a kit of parts to allow the installation as described below. In addition a set of extrusions as shown may be supplied for cutting to length to provide the present invention.

The movable threshold sill assembly consists of a stationary sill member (3) a movable sill member (4) and at least one moving means (5). In this case the moving means (5) sits between and within an assembly of the stationary sill member (3) and movable sill member (4). In the preferred embodiment the movable sill member (4) lies within a sill tray (18), this in turn lies within a sill set out tray (25). The sill tray (18) has sill tray walls (19) and a sill tray base (20).

The sill set out tray (25) and the sill tray (18) form the non-moving parts of the installation.

The moveable sill member (4) has a threshold surface (38) on a threshold portion (7) that extends from an upper portion of the moveable sill member (4). In the embodiment shown the moveable sill member (4) has a base portion (22) from which the threshold portion (7) extends. The movable sill member (4) has base legs (21) which extend downward from the base portion (22). The moveable sill member has about its periphery several locating channels (23) for location of extrusion type strips therein. The function of the various extrusion type strips is dependent on their location and can be for sealing whether for water or air, to act as a cushion, or to present a lower friction surface or to act as a guide. Such a low friction surface is required for when the moveable sill member (4) is in motion relative to the other components of the moveable threshold assembly. The strips can also be to used prevent marking on surfaces, for example as a bearing surface against the door. The strips can also have more than one of these or other functions.

In the preferred embodiment locating channel (23a) on either side of the threshold portion (7) contains “mohair” type seals (11) known in the art used to seal against a door (8).

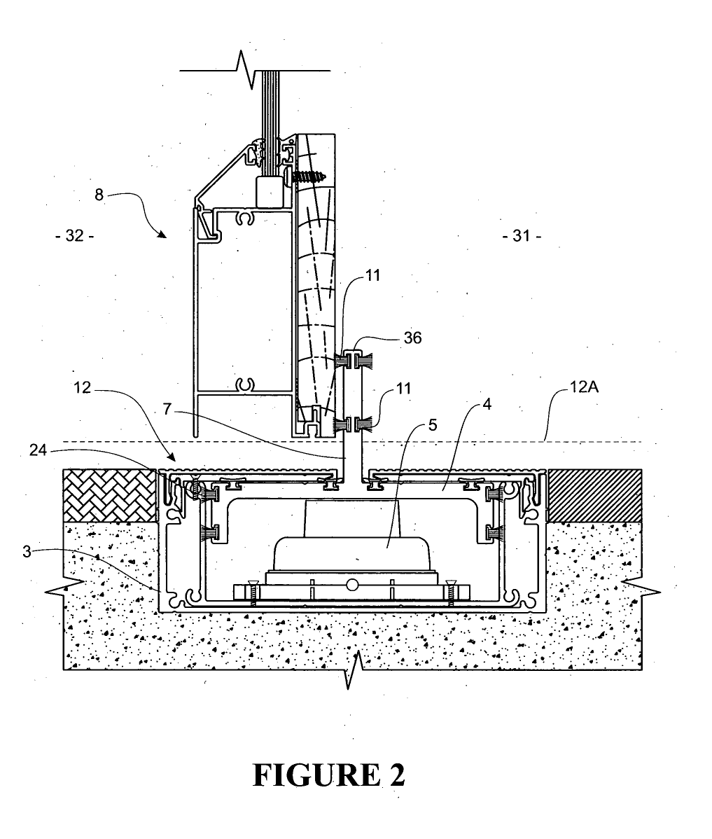

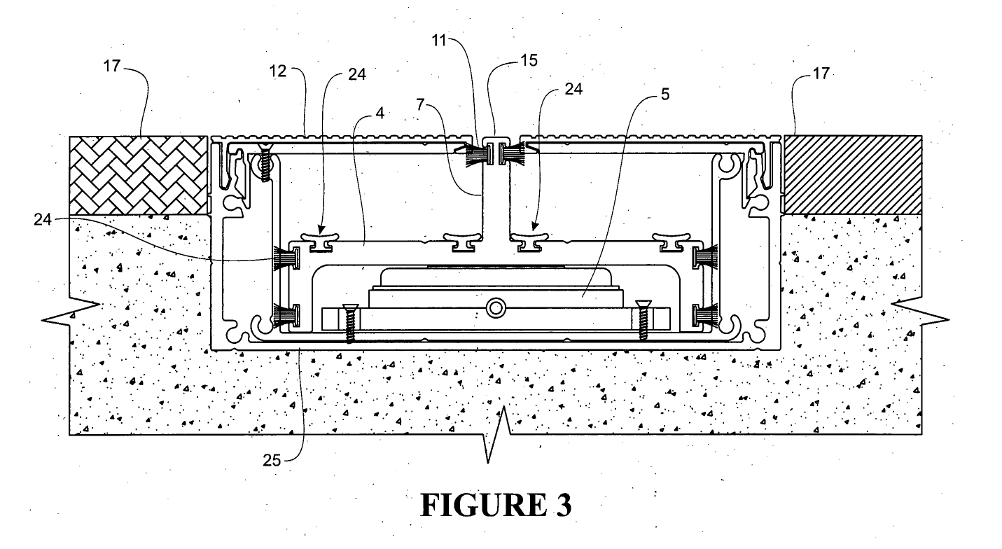

Locating channels (23b) contain a rubber style strip known in the art that is used to cushion (24) the movement of the moveable sill member (4). These are shown in outline in FIG. 3. In use when the moveable sill member (4) is extended as shown in FIG. 2, these will bear on the underside of the blanking member (13) or assembly thereof. These can also act as seals when the movable sill member (4) extended to seal against moisture and debris.

The moveable sill member (4) is dimensioned to fit within the sill tray walls (19) of the sill tray (18). Friction reducing extrusions (24) sit in locating channels (23c). These could be the mohair type seals previously described or other forms of friction reducing materials such as polytetrafluoroethylene in the form of Teflon™ or similar materials. They may also act as a debris seal to prevent materials moving past the base portion (22) of the moveable sill member (4) down to the lower portions of the sill tray (18) or sill set out tray (25).

The moving means (5) can consist of any number of methods to move one component relative to another. For example but not limited to, the moving means (5) may be air actuated, spring actuated (with a system to urge against the spring that can be activated (either for extension or compression of the moving means)), magnetic, electric (whether a linear or rotary electric motor, and whether that is AC or DC) or other means known in the art for moving one member relative to another. In yet other forms of the present invention there may be a sliding mechanical member that has ramping or otherwise causes the movement.

In the preferred embodiment the moving means (5) is an air compressible bladder that will extend upon introduction of compressed air into its internally sealed volume, and then will retract upon removal of the pressurised air. The urging force to collapse the bladder once air pressure is removed may be via an internal or external urging means such as a spring or may be due to the resilient properties of the material forming the bladder of the moving means (5) itself. An air line can be run from a control system to the one or more moving means (5) and upon occurrence of a signalling event the air can be introduced or removed from the air bladder of the moving means (5) (or for any other moving means system actuation or non-actuation of moving means (5)) to allow the moving means (5) to collapse and cause the movable sill member (4) to retract into the assembly.

In the preferred embodiment there are at least two moving means (5) spaced along the movable sill member (4). Preferably the moving means (5) are in controlled movement with each other to ensure an even and consistent extension and retraction of the moveable sill member (4).

The moving means (5) can be affixed to any part of the sill tray (18) or the movable sill member (4). They may also be adjustable mounted relative to the stationary sill member (3). In other forms the moving means (5) may be compressively located between the assembly of the moveable sill member (4) and sill tray (18). For example there may be detents or similar locating means to hold the moving means (5) in the correct position. In still other forms adhesive may be used or other means known in the art, for example fasteners (48), whether threaded or otherwise, for retaining one member to another.

In the preferred embodiment the subassembly of the moveable sill member (4), moving means (5) (and associated control lines) and sill tray (18) is contained within a sill set out tray (25). The sill set out tray provides an outer shell for the subassembly together with keying means for surrounding materials and also has the locating points for blanking member (13) or assemblies thereof. In other embodiments the sill set out tray (25) is not present and the sill tray forms the outer enclosure for the assembly.

Toward the upper edges of the set out tray walls (27) there are locating clips. These engage in a manner that will be described shortly with complimentary features on the blanking member (13) or assembly thereof.

The subassembly of the sill tray (18), moving means (5) and moveable sill member (4) can be affixed to the sill set out tray (25) by adhesives, interference fit, compressive fit, fasteners (48) or otherwise. The sill set out tray (25) with a subassembly therein is blanked off by blanking members (13). In the preferred embodiment the blanking members are an assembly of a top blanking member (29) and a bottom blanking member (28). The top blanking member (29) and bottom blanking member (28) sit together as shown in FIGS. 2 and 3 to form one half of the sill upper surface (12). The blanking members clip or slide into the complimentary apertures on the set out tray walls (27).

When two such assemblies are used on each side of the sill set out tray (25) they leave an elongate aperture (15) of the required length for the length of threshold portion (7) to pass therethrough. The advantage conveyed of having a two part assembly for the blanking member (13) is that a stiffer and more resilient blanking member can be formed that is lighter than a one piece component. Also if one part wears it can easily be replaced. Also if decorative finishes are required these can easily be part of the top blanking member (29). The blanking member assembly (13) is also supported in the preferred embodiment by the upper edges of the sill tray walls (19).

When installing the present invention in the preferred form the sill set out tray (25) is assembled as part of a door frame (2) either in the desired location, i.e. in situ, or as part of a door frame that is then installed into a building, or what is to be come a building.

Thereafter the subassembly of the movable sill member (4), moving means (5) and sill tray (18) is located and fixed into place in the pre-existing assembly. Thereafter the blanking member assembly (13) once any control lines are run is located into place. By using such a method there is little extra work required to provide a movable sill threshold of the present invention and the moveable sill threshold if required can easily be removed for maintenance or other purposes. In a similar way an existing installation can easily be adapted to receive the present invention as an upgrade.

During the installation of the invention a temporary blanking member (34) is located over the sill set out tray (25) to cover it and prevent damage and debris settling in the tray (25) prior to installation of the subassembly as described above, i.e. the subassembly is installed as one of the very last steps to building a building. The temporary blanking member (34) engaging clips at either side of the sill set out tray (25). The temporary blanking member has a stiffening web to bear on the bottom of the tray it is installed in to give added resilience. The temporary blanking member (34) can be made from plastic extrusion or moulding or similar.

In other embodiments the temporary blanking member is located in place once the sub assembly of the movable sill member (4), moving means (5), and blanking members (13) are located in place.

Once construction has finished the temporary blanking member (34) is removed.

When the movable sill member (4) is retracted the upper sill surface (12) (located essentially flush with the level of the surrounding ground surfaces (17)) presents a smooth substantially continuous surface with nothing to snag people, or otherwise, passing therethrough. The surrounding ground surfaces (17) could be the flooring material or ground or otherwise.

In other preferred embodiments a threshold extension (36) can be attached on or to the threshold portion (7) to extend it. This is desirable when for example flooring materials are located over the sill upper surface (12) and therefore a threshold of greater length is required. In the preferred embodiment the threshold extension (36) slides over the top part of the threshold extension (7) and engages the locating channels (23A). If necessary the threshold extension (36) can be fastened or adhered to the threshold portion (7) in known ways. In other forms of the present invention the threshold portion (7) may be completely removable from the movable sill member (4) and can be replaced and whatever length is required can be attached.

When the moving means (5) is actuated to extend the moving means, the movable sill member is pushed up relative to the sill tray (18) to expose at least part of the threshold portion (7). The threshold portion (7) can then act as a threshold and in the preferred embodiment a weather proof seal against any door brought into contact therewith. In the preferred embodiment the threshold portion (7) sits on the inside (31) side of the door assembly. In this way any weather coming from the outside (32) abuts against the door (8) and threshold portion (7) and cannot pass therethrough of at least its passage is substantially reduced.

The present invention may also find application in windows not only doors for in the window has a similar folding, sliding or hinged type arrangement.

In the preferred embodiment actuation of a moving means (5) is dependent on door position. For example as the door is opened the moving means (5) is actuated to retract the moveable sill member (4) and thus the threshold portion (7) to present a substantially flat upper sill surface (12). As the door is closed, for example once a person has passed therethrough, the actuation means energises the moving means (5) to extend and therefore move the moveable sill member (4) upwards to extend the threshold portion (7) where after it can again seal or locate against the inside (31) of a door (8).

In some preferred embodiments the moving means (5) can be independently actuated by a switch or proximity sensor, or various weather conditions. For example if there is no wind or rain and the door is closed then it may be acceptable to have the threshold portion (7) retracted. Once wind or moisture reaches a certain level then the threshold portion (7) can extend and provide a seal against the inside (31) of the door (8). In other embodiments the seal may be against the outside (32) of the door (8) or may be on either side of the door (8) as a locking system to retain the door from moving. In other preferred embodiments the movable sill member (4) or moving means (5) can be locked in either an extended or retracted position as need be. There may also be a fail safe situation whereby should power or activation means to the moving member (5) fail then the moving means (5) will either move to an extended or retracted position or extend or retract the threshold portion (7). In the preferred embodiment such fail safe would extend the moving means (5) reduce a door frame with threshold (7).

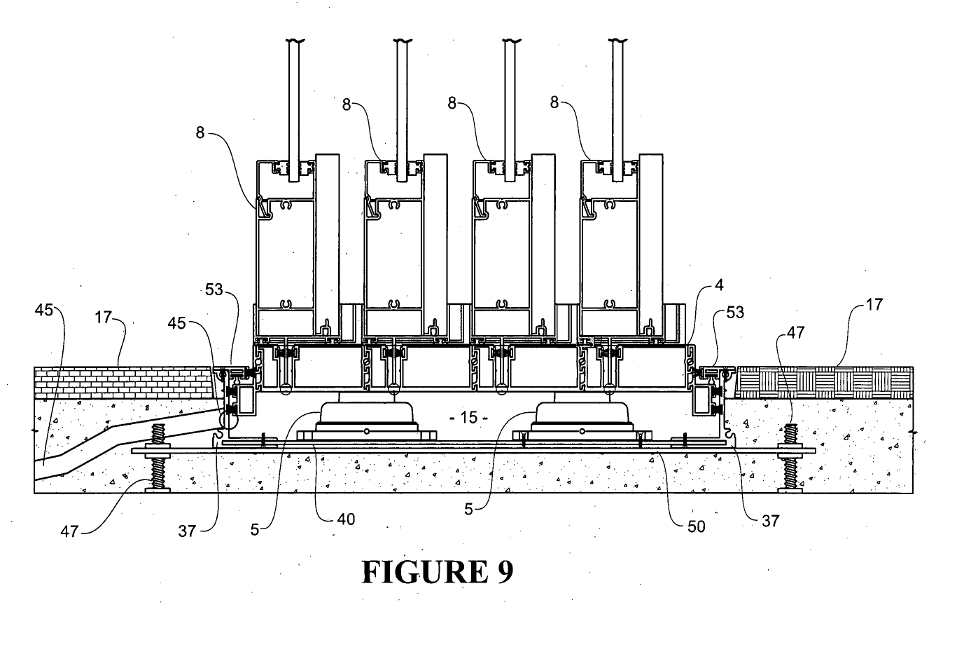

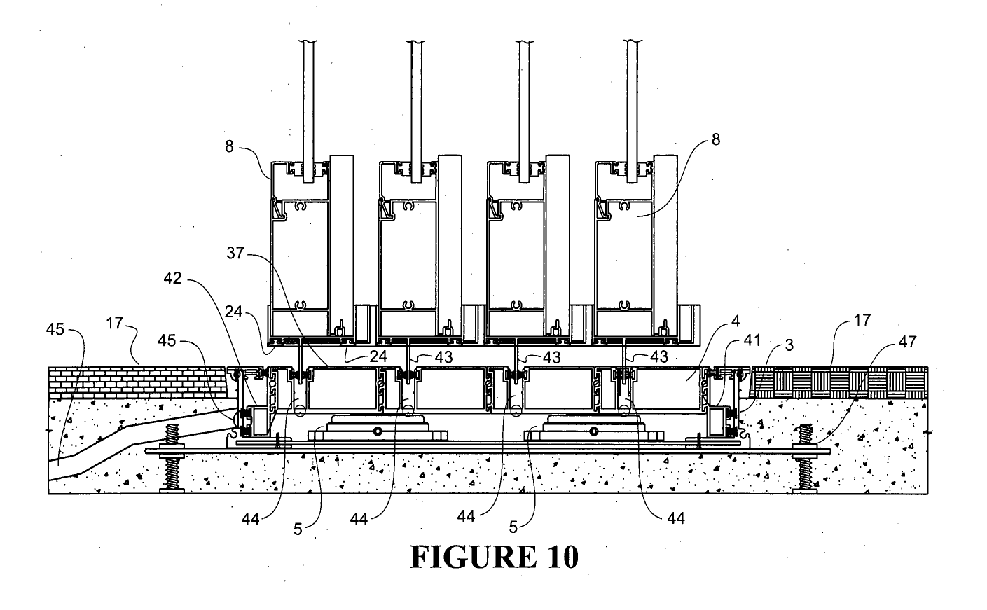

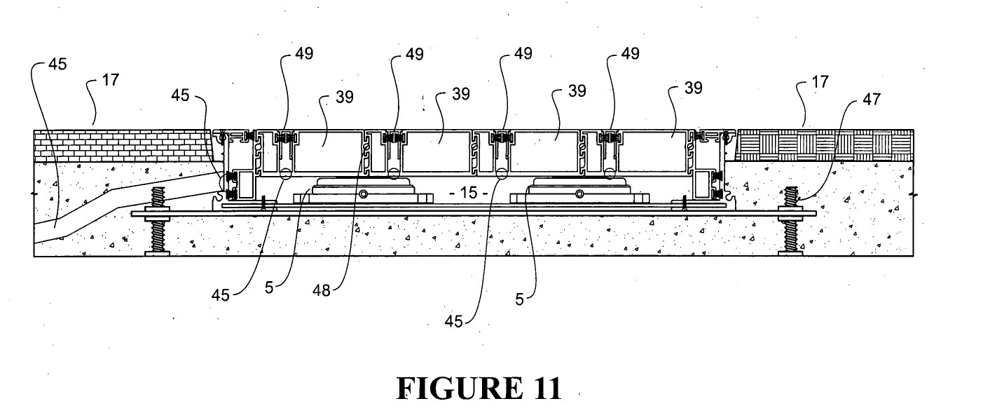

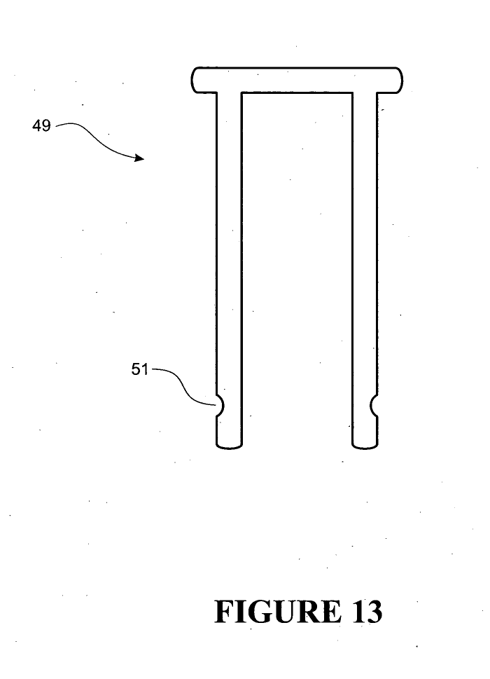

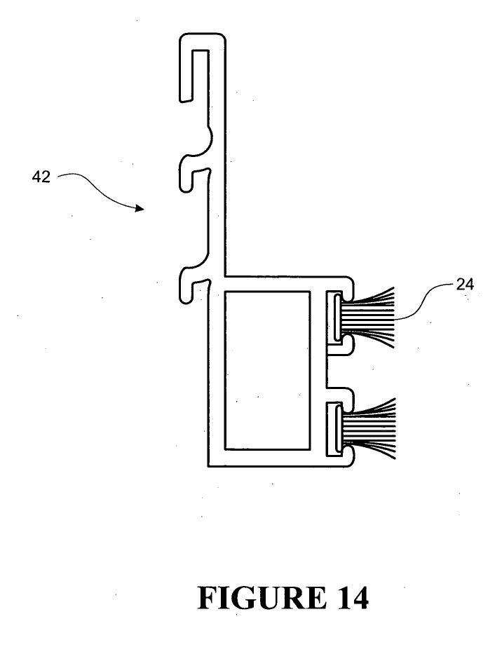

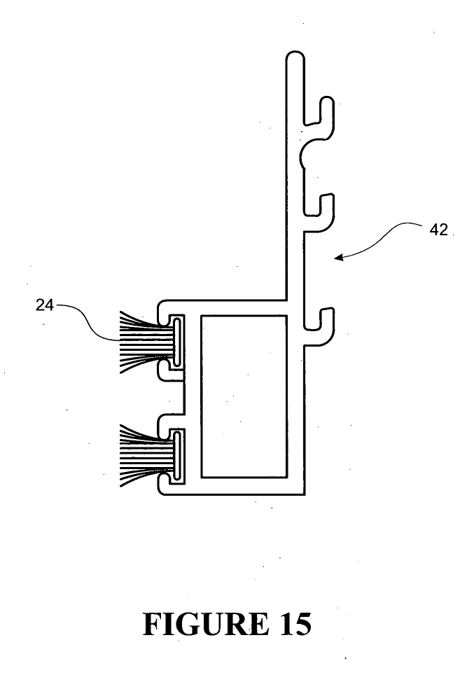

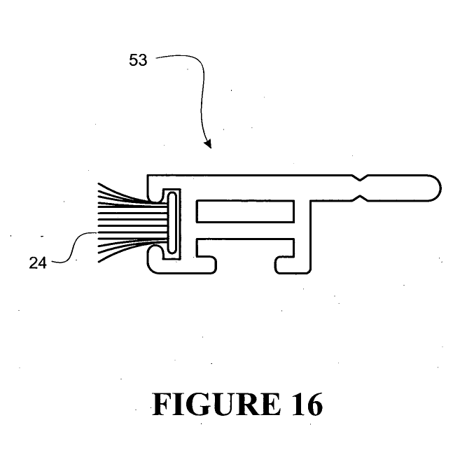

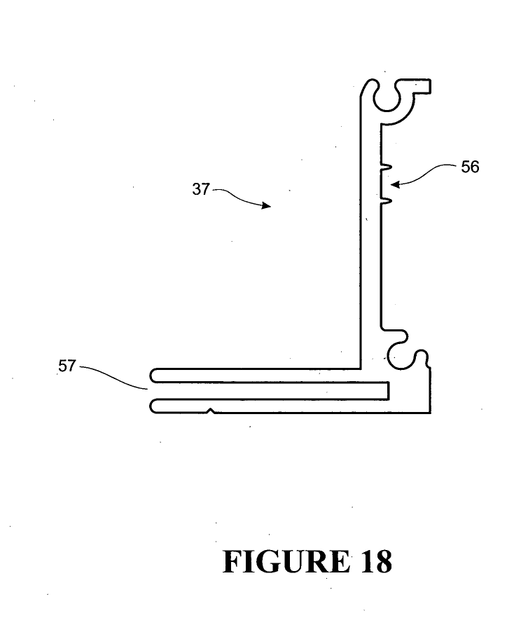

With reference to FIGS. 9 through 18 a further embodiment of the present invention is described. The embodiment is particularly useful for multiple door panels, for example multiple sliding door panels, though with minor modification can also be used for multiple folding door panels (8).

The second embodiment works on a similar principle to that of the first embodiment. Namely there are multiple moving means (5) mounted between a stationary sill member (3) and a moveable sill member (4). In this particular embodiment the stationary sill member (4) is a composite construction comprising a sill tray leg (37) arranged either side of a sill base portion (40). The sill tray leg (37) has an elongate horizontal aperture (57) to receive the sill base portion (40) to define the stationary sill member (3). Keying or levelling points (56) are provided on external or outward surfaces of the sill tray legs (37) to aid in the location, placement and/or adjustment of the assembly relative to the finished or to be finished ground surface level (17). A side top blanking member (53) is installed with the sill tray leg (37) to define the elongate aperture (15) for the moveable sill member (4) to move in. This has the effect of providing an upwardly opening U shape channel similar to that of the first embodiment. The side top blanking member (53) again has cushioning (24) to act as a guide and/or seal against the moveable sill ember (4).

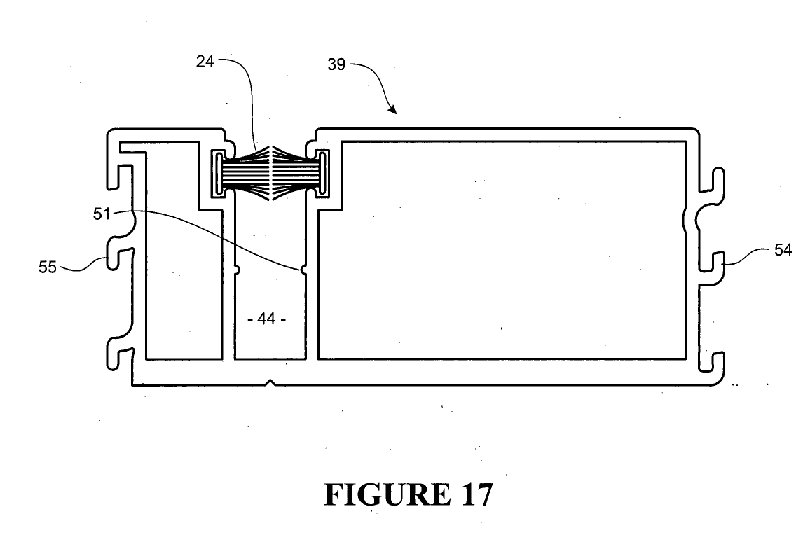

The moveable sill member (4) in this instance is a composite construction comprising of a number of sill plates (39) that engage to each other in a complementary fashion as shown. In the preferred embodiment such complementary fashion is an engagement of upwardly directed hooks or upwardly directed channels (54) on one side of a sill plate engaging with downwardly directed channels (55) on the opposite or engaging side of a second sill plate. The downwardly directed channels (55) and upwardly directed channels (54) of the sill plates (39) can be seen in FIG. 17. The addition of fasteners (48) between the two sill plates locks the two sill plates (39) together.

Due to the composite construction of the stationary sill member (3) and moveable sill member (4) the size of the moveable threshold assembly is scalable depending upon the number of doors (8) that require a moveable threshold.

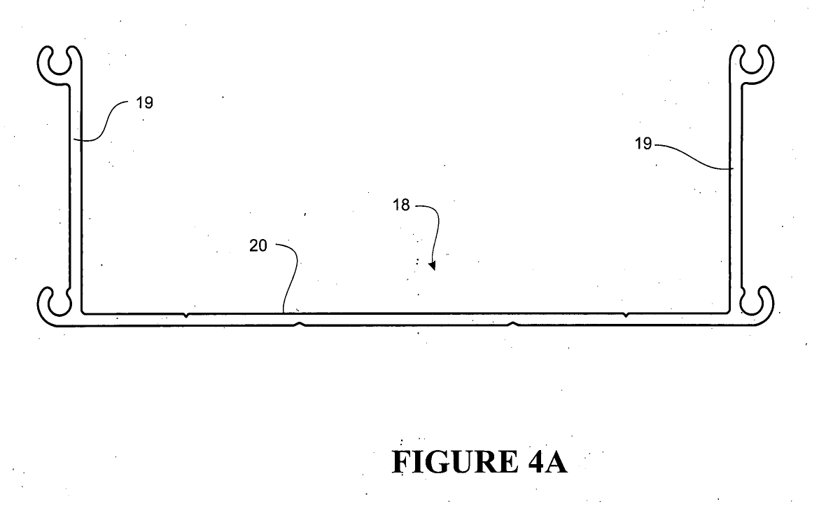

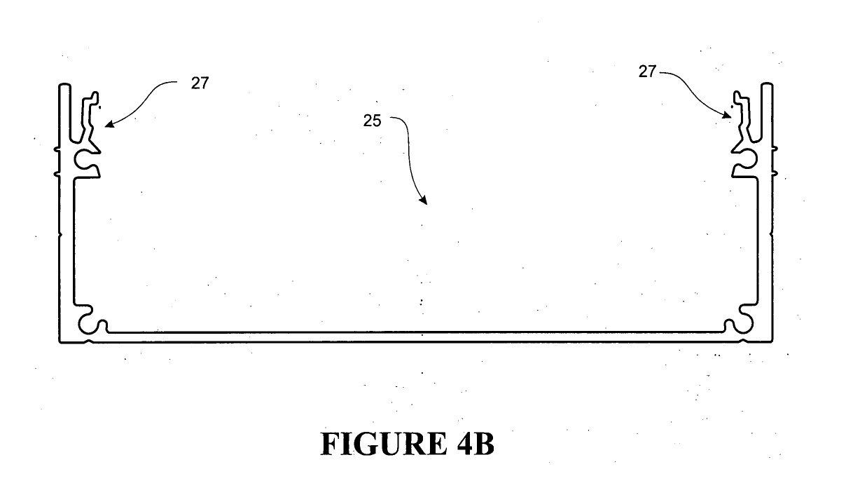

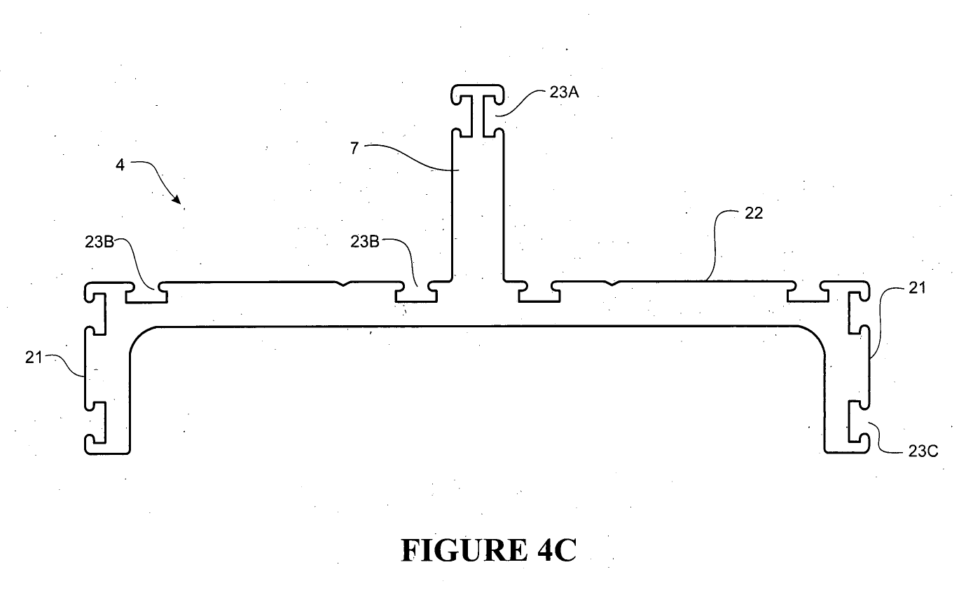

There are left (42) and right (41) side legs that engage on the end surfaces of the multiple sill plates (39) once assembled to provide the equivalent to the base legs (21) shown in FIG. 4(c) for the moveable sill member (4). The side legs engage to the ends of the Movable sill member (4) assembly in a similar way that adjacent sill plates (39) do. Namely by engagement of upwardly directed channels (54) on the sill plate (39) with downwardly directed channels (55) on the side leg and vice versa. In a similar fashion to the first embodiment the side legs (41) and (42) have mounting points as channels thereon to receive cushioning elements (24) to act as guides against the inside surfaces of the sill tray legs (37). The result is a moveable sill member (4) as an assembly that can be displaced between a first position whereby it is retracted at least in part and preferably completely into the stationary sill member (3) to lie flush with the ground surface (17) (when the moveable sill member is installed therein), and a second position whereby the moveable sill member (4) is deployed upwardly to locate near or against the under surface of a door (8) when the door (8) is located in the frame and extending across the opening at the door is to close.

The upper surface of the moveable sill member (4) presents a threshold surface (37). The threshold surface (37) has a number of functions.

When the moveable sill member (4) is in a second position (i.e. retracted) the threshold surface provides a flush surface with that of the ground surface (17). Thus it acts as a surface than can be walked on or passed over.

Then, the moveable sill member (4) can be deployed to extend upwardly from the stationary sill member (3) and ground surface (17). In this position the threshold surface (37) can engage, in the preferred embodiment, the under surface of the door (8).

Located in each of the sill plates (39) is a guide recess (44). The guide recess (44) receives a downwardly directed guide extension (43) of the door (8) with a downwardly directed vertical surface thereon. Either side of the guide recess (44) are channels to allow the location of cushioning (24) to act as a seal and/or guide for the guide extension (43) when located therein.

The relationship of the guide recess (44) and guide extension (43) is such that when engaged therein the door (8) is unable to move transversally of the opening. and is therefore supported at its lower edge.

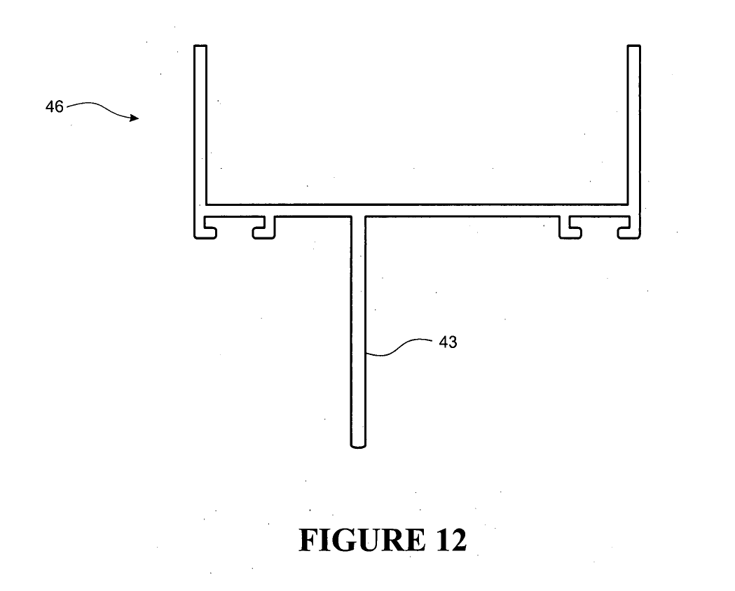

Doors (8) that do not have such a guide extension (43) can be fitted with a guide extension extrusion (46) as shown in FIG. 12. Such an extrusion, as shown in FIG. 12 clips or fastens (48) to the lower surfaces of the door (8) in known ways.

There are drainage holes (and where necessary hoses) (45) to allow the cavity under the moveable sill member (4) to drain of any water or fluids that should collect therein. In ways similar to the first embodiment there are cushioning elements (24) to act as seals between the stationary sill member (3) and moveable sill member (4). This is to prevent ingress of materials therein and also to an extent can provide a guiding function.

The underside of the door panels (8), in addition, have cushioning (24) elements. The sill plates (39) also have drainage holes (45) at the bottom of the guide recess (44) for a similar purpose.

The moving means (5) in the preferred embodiment are adjustably located relative to either the stationary sill member (3) or the assembly of the stationary sill member (3), moving means (5) and moveable sill member (4) is adjustably mounted relative to the ground surface (17). In the preferred embodiment it is this assembly that is adjustably mounted relative to the ground surface (17). Such adjustable mounting is achieved via the assembly sitting on an adjustment plate (50). In turn the adjustment plate (50) via adjustment legs (47) can be moved up and down relative to the ground surfaces (17). Such adjustment allows for alignment of the assembly relative to the ground surfaces (17) to compensate over time for movement or wear, or whereby the level of the grounds surfaces (17) changes (for example flooring), or where there is slope necessary to be imparted to the assembly.

The adjustment legs (47) may for example be threaded to the adjustment plate (50) or other means known in the art for moving one item irrelative to another.

Because of the stacked nature of sliding doors, as shown in FIG. 1(c), the guide recess (44) is not required all the way along the moveable sill member (4) for each door. Rather it is only required for movement of the door from its closed position to its open position via sliding. However in the preferred embodiment the sill plates (39) have the guide recess (44) all the way along their length. Therefore sill guide cover caps (49) are located over that part of the guide recess (44) not required. Such sill guide cover caps (49) also tend to be used during the installation of the moveable threshold assembly to prevent debris et cetera locating into the guide recesses (44). Prior to installation of the doors (8) the sill guide cover caps are removed from that portion of the guide recess (44) that the guide extension (43) of the door (8) has to slide in.

Installation of the second embodiment occurs in a similar fashion to that described earlier. Namely a cavity or trench is provided for the assembly and thereafter the adjustment legs (47) and adjustment plate (50) are located and the stationary sill member (3) and moveable sill member (4) are located there afterwards.

In some preferred embodiments the moving means (5) and moveable sill member (4) are located in place toward the very end of construction for reasons described, namely to prevent damage and contamination by building debris. In such a situation where these parts are installed at a late as possible point some form of cover is located over the aperture that the stationary sill member (3) would otherwise provide.

The sill guide cover caps (49) engage via complementary points (51) on their legs with complementary points in the guide recess (44).

One mode of use of the second embodiment, when the doors (8) are located to close off the aperture, is as follows. The doors (8) maybe slide to either side of the aperture of the doorway and thereafter the moveable sill member (4) can be lowered. Alternatively the moveable sill member (4) is lowered prior to opening of the doors (8). This can be used as a security feature if the doors (8) are prevented from moving prior to retraction of the movable sill member. The activation of the moveable sill member (4) to move to this second position can be automatic and is actuated for example by detection of moving of the doors. Alternatively such activation can occur via the user directly actuating such movement for example by a switch or button to activate the moving means (5). The result when the removable sill member (4) is retracted and the doors (8) are opened is a threshold of the sill (1) that is flush with the surrounding ground surfaces (17) and provides minimal intrusion into the doorway (58).

The foregoing description of the invention includes preferred forms thereof. Modifications may be made thereto without departing from the scope of the invention.

1. A sill for a door frame, whether a door is hinged, sliding, or bi-fold or otherwise, comprising or including
a stationary sill member, whether of unitary or composite construction,
a movable sill member with a surface thereon to act as a threshold (hereafter “threshold surface”) for said sill, and
at least one moving means,
wherein said at least one moving means acts on said movable sill member, directly or indirectly to move said movable sill member between,
a first position wherein said threshold surface is retracted at least in part toward or within said stationary sill member, and
a second position wherein said threshold surface is extended from said stationary sill member,
said at least one moving means energised by a controlling event.

2. The sill as claimed in claim 1, wherein said controlling event is linked to said door position relative said frame.

3. The sill as claimed in claim 1, wherein said at least one moving means is energised to move said movable sill member and extend said threshold surface to said second position when said door is closed in said door frame.

4. The sill as claimed in claim 1, wherein said event is the opening of said door to energise said at least one moving means to move said moveable sill member to said first position and retract said threshold surface.

5. The sill as claimed in claims 1, wherein said at least one moving means is energised independent of said door position.

6. The sill as claimed in claim 1, wherein said controlling event is linked to wind or wind pressure or the presence of moisture to cause said movable sill member to move to said second position and extend said threshold surface.

7. The sill as claimed in claim 1, wherein said threshold surface and said movable sill member move in the vertical direction between said first position and said second position.

8. The sill as claimed in claim 1, wherein said threshold surface is located on an extension or a recess (hereafter “threshold portion”) of said movable sill member.

9. The sill as claimed in claim 8, wherein said threshold portion is at least one elongate member, extending from said movable sill member, running lengthwise along said sill and extending to engage against a substantially vertical surface of said door when said door is in said frame and said threshold portion is extended.

10. The sill as claimed in claim 1, wherein said threshold surface is provided as at least one surface of a vertical recess in said movable sill member, or part thereof.

11. The sill as claimed in claim 1, wherein said movable sill member is a unitary member, such as an extrusion.

12. The sill as claimed in claim 1, wherein said moveable sill member is a composite member assembled from several individual members, such as several extrusions.

13. The sill as claimed in claim 1, wherein there is a seal formed by a sealing element between said door, when in said frame, and said movable sill member.

14. The sill as claimed in claim 1, wherein there is a cushioning element between said door and said threshold surface, with either,
a cushioning element on said threshold surface to cushion against a surface of said door, or
a cushioning element on said door, or a part thereof, to cushion against said threshold surface,
or both,
when said door is in said frame and said threshold surface is extended.

15. The sill as claimed in claim 14, wherein said cushioning element acts as a guide in addition to being a cushion.

16. The sill as claimed in claim 14, wherein said cushioning element acts as said sealing element.

17. The sill as claimed in claim 13, wherein a said sealing element is located on a downward facing surface of said door to seal against a horizontal portion of the threshold surface, when said door is in said door frame.

18. The sill as claimed in claim 1, wherein said at least one moving means is energised by any one or more of:
(i) a spring
(ii) air
(iii) a liquid
(iv) an electrical system, such as a linear or a rotary motor, or
(v) any combination of (i), (ii), (iii) or (iv).

19. The sill as claimed in claim 1, wherein said at least one moving means is an air actuated bladder.

20. The sill as claimed in claim 1, wherein said at least one moving means is adjustable mounted to or on said stationary sill member.

21. The sill as claimed in claim 1, wherein said at least one moving means is mounted on a platform that is adjustable relative to said stationary sill member.

22. The sill as claimed in claim 1, wherein said threshold surface lies flush with or below an upper surface of said stationary sill member when said moveable sill member is in said first position.

23. The sill as claimed in claim 8, wherein said threshold surface is extended from an elongate aperture in said stationary sill member or a blanking member in or on said stationary sill member.

24. The sill as claimed in claim 23, wherein said threshold portion has a closing portion that closes off said elongate aperture when in said first position.

25. The sill as claimed in claim 1, further comprising guides to guide said movable sill member between said first and second position.

26. The sill as claimed in claim 25, wherein said guides lie between vertical faces of said movable sill member and vertical faces of said stationary sill member.

27. The sill as claimed in claim 1, wherein said movable sill member is operable to a position intermediate of said first and said second positions.

28. The sill as claimed in claim 22, wherein said sill is installed such that said upper surface is substantially flush with ground surfaces into which said sill is installed.

29. The sill as claimed in claim 1, wherein said movable sill member is locked or is lockable, directly or indirectly in either said first position, said second position or an intermediate position between said first and said second positions.

30. The sill as claimed in claim 1, wherein said movable sill member is energised to extend upon a failure of the moving means.

31. The sill as claimed in claim 1, wherein said stationary sill member is of a unitary or a composite construction.

32. The sill as claimed in claim 1, wherein said stationary sill member is constructed of an upwardly opening U-shaped sill set out tray or channel.

33. The sill as claimed in claim 32, wherein said stationary sill member is constructed from two end pieces and a base piece to define the sides and base respectively of the upwardly opening U-shaped sill set out tray or channel.

34. The sill as claimed in claim 32, wherein said upwardly opening U- shaped sill set out tray or channel is in part closed by one or more blanking members to define an elongate aperture.

35. The sill as claimed in claim 34, wherein said one or more blanking members are of a composite construction, having a top blanking member and a bottom blanking member.

36. The sill as claimed in claim 34, wherein said blanking members at least in part clip into said upwardly opening U-shaped sill set out tray or channel at either side of said tray or channel.

37. The sill as claimed in claim 32, wherein said at least one moving means is contained in or on a sill tray located at least in part within said upwardly opening U-shaped sill set out tray or channel.

38. A method of providing a sill, comprising or including,
providing a sill with a movable portion therein to extend and retract a threshold surface therefrom,
extending said threshold surface from said sill to seal against a door when said door is at least in proximity to said sill,
retracting said threshold surface into said sill when said door is at least not in proximity to said sill,
said threshold surface when retracted providing a substantially smooth uninterrupted upper surface of said sill.

39. A method of installing a sill with a movable threshold, comprising or including the steps of:
(i) locating a stationary sill member in or with a door frame, whether in situ or otherwise,
(ii) installing a at least one moving means and a movable sill member adapted to be moved by said at least one moving means, either as individual components or a subassembly into said stationary sill member,
(iii) locating blanking members to provide an elongate aperture for a threshold portion of said movable sill member to extend from and retract at least in part into.

40. The method as claimed in claim 39, wherein a control means to control said at least one moving means is installed at any step in said method.

41. The method as claimed in claim 39, wherein a temporary blanking member is located over the stationary sill member during construction and installation of the sill.

42. The method as claimed in claim 39, wherein a temporary blanking member is located over the stationary sill member between steps i) and ii) during construction and installation of the sill.

43. The method as claimed in claim 39, wherein said door frame is a door frame that is then installed in an opening in a building to then be closed or is closable by a door, whether said door is located or is to be located, in said door frame.

44. The method as claimed in claim 43, wherein said door is hinged, sliding, or bi-fold or otherwise moveable relative to said sill or door frame.

45. A kit or combination to provide a movable threshold sill or door frame with a movable threshold sill, said kit or combination comprising or including,
a sill assembly having a stationary sill member,
a movable sill member and a threshold surface extending there from,
at least one movable means to move said movable sill member, and
optionally a control to control energisation of said movable means.

46. (canceled)

47. (canceled)

48. (canceled)
